(19) United States
(12) Patent Application Publication
(10) Pub. No.: US 2023/0292772 A1
(43) Pub. Date: Sep. 21, 2023

(54) FROZEN GYOZA DUMPLINGS AND PRODUCTION METHOD THEREFOR, TRAY FOR FROZEN GYOZA DUMPLINGS, AND PACK OF FROZEN GYOZA DUMPLINGS

(71) Applicant: AJINOMOTO CO., INC., Tokyo (JP)

(72) Inventors: Kaoru HOSOKAWA, Kawasaki-shi (JP); Yoshinori KODANI, Kawasaki-shi (JP)

(73) Assignee: AJINOMOTO CO., INC., Tokyo (JP)

(21) Appl. No.: 18/185,466

(22) Filed: Mar. 17, 2023

(30) Foreign Application Priority Data
Mar. 18, 2022 (JP) 2022-044584

(51) Int. Cl. A21D 13/31; A21D 15/02; A21D 10/04; B65D 25/04

(52) U.S. Cl. CPC A21D 13/31; A21D 15/02; A21D 10/04; B65D 25/04; B65D 2571/00333

(57) ABSTRACT

Frozen gyoza dumplings containing a plurality of frozen gyoza dumplings connected by a frozen batter permit easy division into the required number in a frozen state, and can be easily taken out in a connected state from a tray.

### CROSS REFERENCES TO RELATED APPLICATION

This application claims priority to Japanese Patent Application No. 2022-044584, filed on Mar. 18, 2022, which is incorporated herein by reference in its entirety.

### BACKGROUND OF THE INVENTION

### Field of the Invention

The present invention relates to frozen gyoza dumplings in which a plurality of frozen gyoza dumplings is connected by a frozen batter, a production method for the frozen gyoza dumplings, a tray for storing the frozen gyoza dumplings, and a pack of frozen gyoza dumplings stored in the aforementioned tray.

### Discussion of the Background

When cooking frozen gyoza dumplings, it is troublesome to take out gyoza dumplings one by one from the tray and arrange them on cooking utensils such as a frying pan. Therefore, there is a need to eliminate the trouble by taking out the connected gyoza dumplings at one time.

To meet such needs, various proposals have conventionally been made and, for example, frozen connected gyoza dumplings with emulsified batter liquid (see JP-B-4483268, which is incorporated herein by reference in its entirety), frozen gyoza dumplings in a tray in which plural gyoza dumplings are connected to each other and immobilized on the tray bottom surface (see JP-B-4584497, which is incorporated herein by reference in its entirety), tray for gyoza dumplings capable of connecting and freezing plural gyoza dumplings (see JP-A-H11-56313, which is incorporated herein reference in its entirety), fats and oils composition for gyoza dumplings which is used for connecting and solidifying by freezing gyoza dumplings (see JP-B-6646963, which is incorporated herein by reference in its entirety), and the like are known.

### SUMMARY OF THE INVENTION

However, in simply-connected frozen gyoza dumplings, the shape of the connected frozen dumplings is defined by the direction of connection. Therefore, problems exist in that it takes time for the user to adjust the number of gyoza dumplings to be cooked according to the shape of cooking utensils such as a frying pan, or to arrange the gyoza dumplings freely (for example, arrange plural gyoza dumplings in a disk shape).

These and other objects, which will become apparent during the following detailed description, have been achieved by the present inventor's discovery.

The main constitutions of the present invention are as follows.
(1) Frozen gyoza dumplings comprising a plurality of frozen gyoza dumplings connected by a frozen batter, wherein
   a cutting plane formed by separating adjacent frozen gyoza dumplings by cutting at a part where they are connected by a frozen batter is a cutting plane (1), a plane parallel to the cutting plane (1) and formed by cutting the frozen gyoza dumpling along a plane passing through the center of a marginal part of the frozen gyoza dumpling is a cutting plane (2),
(i) when the cutting plane (1) and the cutting plane (2) are flat planes, an area of the part connected by the frozen batter in the cutting plane (1) is P, both ends of an upper side of the frozen batter in the longitudinal direction in the cutting plane (2) are respectively A and D, one of the both ends of the bottom surface of the frozen gyoza dumpling, or one of the both ends of the frozen batter at the same height as the bottom surface of the frozen gyoza dumpling, or one of the both ends at the lower side of the frozen batter beneath and attached to the bottom surface of the frozen gyoza dumpling, which is closer to A in the horizontal direction, is B and the other end closer to D in the horizontal direction C, and an area of a quadrangle formed by ABCD is Q,
(ii) when the cutting plane (1) and the cutting plane (2) are curved surfaces, an area of the part connected by the frozen batter in a cutting plane created by developing the cutting plane (1) on a flat plane is P, both ends of an upper side of the frozen batter in the longitudinal direction in a cutting plane created by developing the cutting plane (2) on a flat plane are respectively A and D, one of the both ends of the bottom surface of the frozen gyoza dumpling, or one of the both ends of the frozen batter at the same height as the bottom surface of the frozen gyoza dumpling, or one of the both ends at the lower side of the frozen batter beneath and attached to the bottom surface of the frozen gyoza dumpling, which is closer to A in the horizontal direction, is B and the other end closer to D in the horizontal direction is C, and an area of a quadrangle formed by ABCD is Q, and
P: (Q-P) is 1:5.5 to 1:28.
(2) The frozen gyoza dumplings of (1), wherein a lower side in the longitudinal direction of the part connected by the frozen batter has undulations.
(3) The frozen gyoza dumplings of (1) or (2), wherein only one frozen gyoza dumpling is placed in a cuboid with a long side length L, a short side length S, and a height H, wherein L is a length in the longitudinal direction, S is a length in the short side direction, and H is a height of the frozen gyoza dumpling.
(4) The frozen gyoza dumplings of any one of (1) to (3), wherein the frozen batter consists of a batter liquid comprising water, fats and oils, and an emulsifier, and further comprising one or more selected from grain flour, starch, and protein.
(5) The frozen gyoza dumplings of any one of (1) to (4), which are stored in a tray.
(6) Frozen gyoza dumplings stored in a tray, wherein
   the tray comprises a plurality of receiving parts for individually placing a plurality of frozen gyoza dumplings,
   the plural receiving parts are connected with a partitioning protrusion set between respective receiving parts, and form one or more rows, and
   a ratio of an area of the part connected by the frozen batter and an area of other part is 1:5.5 to 1:28 in (i) or (ii) below:
      when adjacent frozen gyoza dumplings are cut along the longitudinal direction of the partitioning protrusion,
(i) a quadrangle A′B′C′D′ in a sectional view when the cutting plane is a flat plane, wherein A′ and D′ are respectively the both ends of the frozen batter at the height thereof and at the inner side of the side wall of the receiving part in the sectional view, B′ is one of the both ends of the supporting surface in the longitudinal direction which is closer to A′ in the horizontal direction, and C′ is the other end closer to D′ in the horizontal direction,
(ii) a quadrangle A′B′C′D′ in a sectional view created by developing the cutting plane on a flat plane when the cutting plane is a curved surface, wherein A′ and D′ are respectively the both ends of the frozen batter at the height thereof and at the inner side of the side wall of the receiving part in the sectional view, B′ is one of the both ends of the supporting surface in the longitudinal direction which is closer to A′ in the horizontal direction, and C′ is the other end closer to D′ in the horizontal direction.
(7) The frozen gyoza dumplings of (6), wherein the gyoza dumplings are stored in a tray with partitioning protrusions whose top surface has undulations.
(8) The frozen gyoza dumplings of (6) or (7), wherein the gyoza dumplings are stored in a tray in which a height of the both ends of the partitioning protrusion in the longitudinal direction is the same as or higher than a height of other parts of the partitioning protrusion.
(9) A tray for storing frozen gyoza dumplings consisting of a plurality of frozen gyoza dumplings connected by a frozen batter, the tray comprising plural receiving parts for individually placing a plurality of frozen gyoza dumplings, wherein
   the plural receiving parts are connected with a partitioning protrusion set between respective receiving parts, and form one or more rows, and
   when the frozen gyoza dumplings consisting of a plurality of frozen gyoza dumplings connected by the frozen batter are stored, the plural receiving parts store the plurality of connected frozen gyoza dumplings such that a ratio of an area of the part connected by the frozen batter and an area of other part is 1:5.5 to 1:28 in (i) or (ii) below:
   when adjacent frozen gyoza dumplings are cut along the longitudinal direction of the partitioning protrusion,
(i) a quadrangle A′B′C′D′ in a sectional view when the cutting plane is a flat plane, wherein A′ and D′ are respectively the both ends of the frozen batter at the height thereof and at the inner side of the side wall of the receiving part in the sectional view, B′ is one of the both ends of the supporting surface in the longitudinal direction which is closer to A′ in the horizontal direction, and C′ is the other end closer to D′ in the horizontal direction,
(ii) a quadrangle A′B′C′D′ in a sectional view created by developing the cutting plane on a flat plane when the cutting plane is a curved surface, wherein A′ and D′ are respectively the both ends of the frozen batter at the height thereof and at the inner side of the side wall of the receiving part in the sectional view, B′ is one of the both ends of the supporting surface in the longitudinal direction which is closer to A′ in the horizontal direction, and C′ is the other end closer to D′ in the horizontal direction.
(10) The tray of (9), wherein the partitioning protrusions have a top surface with undulations.
(11) The tray of (9) or (10), wherein a height of the both ends of the partitioning protrusion in the longitudinal direction is the same as or higher than a height of other parts of the partitioning protrusion.
(12) A pack of frozen gyoza dumplings with a constitution in which a plurality of frozen gyoza dumplings connected by a frozen batter is arranged in the tray of any one of (9) to (11).
(13) A method for producing frozen gyoza dumplings consisting of a plurality of frozen gyoza dumplings connected by a frozen batter, the method comprising
   a step of injecting a batter liquid in the tray of any one of (9) to (11),
   a step of setting an unfrozen gyoza dumpling or a frozen gyoza dumpling in each receiving part of the tray, and
   a step of freezing the batter liquid injected in the tray and the unfrozen gyoza dumpling or frozen gyoza dumpling set in each receiving part of the tray while they are in contact with each other.

### Effect of the Invention

According to the present invention, gyoza dumplings in a frozen state can be divided into the required number. Thus, frozen gyoza dumplings that are easily taken out in a connected state from a tray are preferably provided.

According to the present invention, moreover, a production method of the frozen gyoza dumplings, a tray for storing the frozen gyoza dumplings, and a pack of frozen gyoza dumplings in which the frozen gyoza dumplings are stored in the aforementioned tray are also provided.

### BRIEF DESCRIPTION OF THE DRAWINGS

FIGS. 1A to 1F are schematic diagrams to explain the frozen gyoza dumplings of the present invention. FIG. 1A is a top view (plan view) of the frozen gyoza dumplings of the present invention. FIG. 1B is one embodiment of a view showing the X1-X1 cross-sectional arrow view of the frozen gyoza dumplings shown in FIG. 1A in which a frozen batter is not attached to the bottom surface of the frozen gyoza dumplings. In FIG. 1B, the filling inside the gyoza dumpling is omitted. FIG. 1C is a view showing the X2-X2 cut section end surface arrow view of the frozen gyoza dumplings shown in FIG. 1A. In FIG. 1C, the outline of the frozen gyoza dumpling, which is not actually visible, is shown with a dotted line. In these figures, the frozen batter is hatched, and the same applies to FIG. 1D to FIG. 1F, FIGS. 3A and 3B, and FIGS. 6A to 6D.

FIG. 1D is a view showing the X3-X3 cut section end surface arrow view of the frozen gyoza dumplings shown in FIG. 1A and corresponds to FIG. 1B. FIG. 1E is another embodiment of a view showing the X1-X1 cross-sectional arrow view of the frozen gyoza dumplings shown in FIG. 1A in which a frozen batter is attached to the bottom surface of the frozen gyoza dumplings. FIG. 1F is a view showing the X3-X3 cut section end surface arrow view of the frozen gyoza dumplings shown in FIG. 1A and corresponds to FIG. 1E. In these figures, the filling inside the gyoza dumpling is omitted.

FIGS. 2A to 2D exemplarily show a typical shape of gyoza dumpling, in which the shape of each part is simplified to explain the name of each part of the gyoza dumpling. FIG. 2A is a perspective view of gyoza dumpling having a typical shape. In FIG. 2B, the shape of the side surface of the gyoza dumpling shown in FIG. 2A is seen along the direction of arrow X10 therein and schematically expressed as a simple half moon shape. In FIG. 2C, the shape of the bottom surface of the gyoza dumpling shown in FIG. 2B is schematically expressed as a simple crescent shape. FIG. 2D shows a sectional view on arrows Y10-Y10 of the gyoza dumpling shown in FIG. 2B. In FIG. 2D, the filling is not shown and the section is hatched.

FIGS. 3A and 3B are schematic diagrams to explain the tray of the present invention. FIG. 3A is a top view (plan view) of the frozen gyoza dumplings of the present invention arranged in the tray of the present invention. FIG. 3B is a view showing the X4-X4 sectional arrow view of the tray shown in FIG. 3A. In FIGS. 3A and 3B, lines not actually visible are shown with a dotted line.

FIG. 4 is a schematic diagram showing another embodiment of the tray of the present invention, and is a top view (plan vie) without the frozen gyoza dumplings of the present invention. In FIG. 4, partitioning protrusions are hatched.

FIGS. 5A to 5D are views showing embodiments of the cross sectional shape of the partitioning protrusion in the tray of the present invention.

FIGS. 6A to 6D exemplarily show a quadrangle A′B′C′D′ when a partitioning protrusion with the cross sectional shape shown in FIG. 5B is used. In FIGS. 6A to 6D, a frozen gyoza dumpling is not shown.

### DETAILED DESCRIPTION OF THE PREFERRED EMBODIMENTS

The constitution of the frozen gyoza dumplings of the present invention is first explained in detail by referring to Figures.

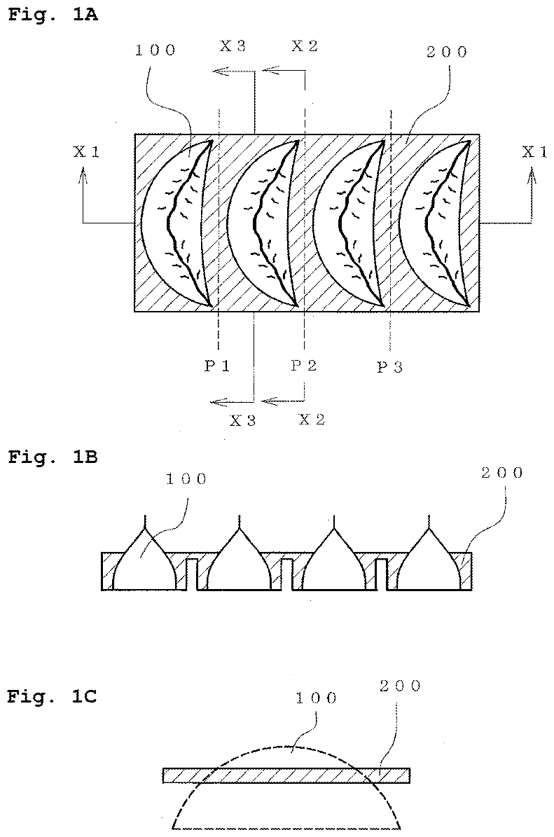

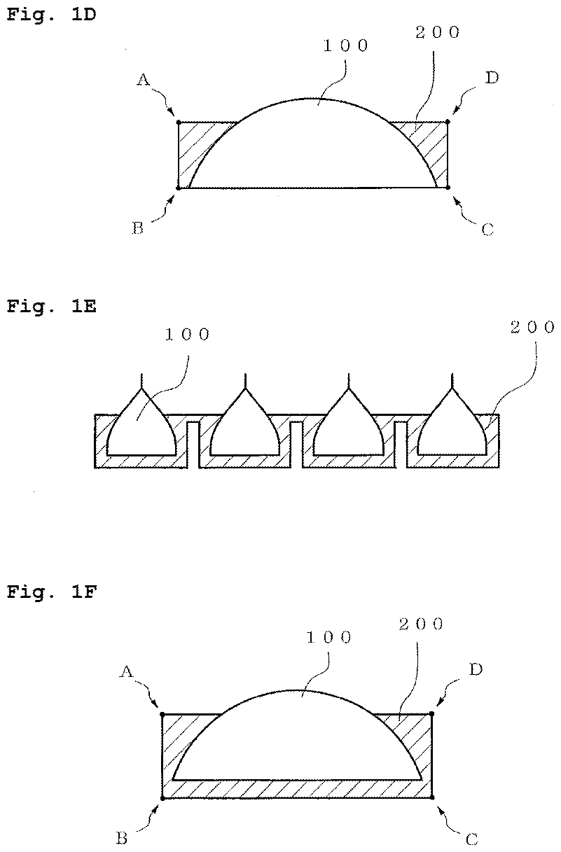

The frozen gyoza dumplings of the present invention include, as schematically shown in the constitution of one embodiment of FIGS. 1A to 1F, a plurality of frozen gyoza dumplings 100 and a frozen batter 200 to connect the plurality of frozen gyoza dumplings 100.

The frozen gyoza dumplings of the present invention are characterized in that the plurality of connected frozen gyoza dumplings 100 can be easily divided into the required number in a frozen state.

For example, when the number of frozen gyoza dumplings 100 is four, as Shown in FIG. 1A,
(1) it is easy to divide one by one by setting the dividing positions to P1, P2, and P3,
(2) it is easy to divide into two by setting the dividing position to P2, and
(3) it is easy to divide into 1 dumpling and 3 dumplings by setting the dividing position to P1 or P3.

The conditions under which such division is preferably realized are as follows.

That is, the conditions are as follows.

When a cutting plane formed by separating adjacent frozen gyoza dumplings 100 by cutting at a part where they are connected by a frozen batter 200 is a cutting plane (1), a plane parallel to the cutting plane (1) and formed by cutting the frozen gyoza dumpling 100 along a plane passing through the center of a marginal part of the frozen gyoza dumpling 100 is a cutting plane (2),
(i) when the cutting plane (1) and the cutting plane (2) are flat planes (that is, when the part connected by frozen batter 200 is along the longitudinal direction of frozen gyoza dumpling 100), an area of the part connected by the frozen batter 200 in the cutting plane (1) (e.g., X2-X2 cut section end surface arrow view of FIG. 1C) is P, both ends of an upper side of the frozen batter 200 in the longitudinal direction in the cutting plane (2) (e.g., X3-X3 cut section end surface arrow views of FIG. 1D and FIG. 1F) are respectively A and D, one of the both ends of the bottom surface of the frozen gyoza dumpling 100, or one of the both ends of the frozen batter 200 at the same height as the bottom surface of the frozen gyoza dumpling 100, or one of the both ends at the lower side of the frozen batter 200 beneath and attached to the bottom surface of the frozen gyoza dumpling 100, which is closer to A in the horizontal direction is B and the other end closer to D in the horizontal direction is C, and an area of a quadrangle formed by ABCD (typically rectangle as shown in FIG. 1D and FIG. 1F, but other quadrangles including trapozoid, inverted trapozoid, and parallelogram are not excluded) is Q,
(ii) when the cutting plane (1) and the cutting plane (2) are curved surfaces (that is, when the part connected by frozen batter 200 curves along the shape of frozen gyoza dumpling 100), an area of the part connected by the frozen batter 200 in a cutting plane created by developing the cutting plane (1) on a flat plane is P, both ends of an upper side of the frozen batter 200 in the longitudinal direction in a cutting plane created by developing the cutting plane (2) on a flat plane are respectively A and D, one of the both ends of the bottom surface of the frozen gyoza dumpling 100, or one of the both ends of the frozen batter 200 at the same height as the bottom surface of the frozen gyoza dumpling 100, or one of the both ends at the lower side of the frozen batter 200 beneath and attached to the bottom surface of the frozen gyoza dumpling 100, which is closer to A in the horizontal direction, is B and the other end closer to D in the horizontal direction is C, and an area of a quadrangle formed by ABCD is Q, and
P: (Q-P) is preferably 1:5.5 to 1:28, more preferably 1:6 to 1:20, further preferably 1:7 to 1:12.

As a method for developing a curved surface into a flat plane, developable surfaces such as a cylindrical surface or a conical surface can to simply developed into a flat surface since such curved surface was created by curving the original straight sides. In the case of non-developable surfaces such as a spherical surface, for example, the least-squares method is used to create an approximate developable surface and the surface is developed.

When the above-mentioned ratio is greater than the above-mentioned range, it becomes difficult to divide the plural frozen gyoza dumplings 100 into a required number. When such ratio is smaller than the above-mentioned range, for example, it becomes difficult to take out plural frozen gyoza dumplings 100 in a connected state from the tray in which they are stored.

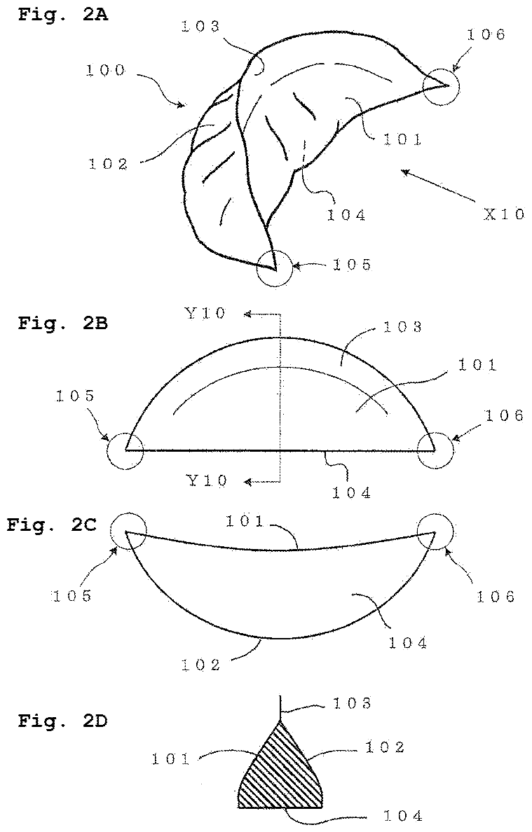

A typical shape of a frozen gyoza dumpling 100 in the frozen gyoza dumplings of the present invention is a curved three-dimensional shape having a longitudinal direction as exemplarily shown in FIG. 2A. However, the shape of the gyoza dumpling exemplified in this Figure is a most general one and there are many variations including one free of a curve, one with a long or short marginal part (seam of dough), one with a flat or curved bottom, and the like.

In the present specification, to simplify explanation, the shape of gyoza dumpling seen from the side (shape of the side surface when seen along the direction of arrow X10 in FIG. 2A) is expressed by a simple half-moon shape shown in FIG. 2B), and the shape of the bottom surface of gyoza dumpling is expressed by a simple crescent moon shape shown in FIG. 2C. In addition, a cross sectional shape when a gyoza dumpling is cut along the short side (shape appearing as cross-sectional view on arrow Y10-Y10 in FIG. 2B) is expressed as a simple shape of triangular top part with swollen side surfaces shown in FIG. 2D, which is added with a line segment showing a marginal part 103.

A frozen gyoza dumpling 100 having a typical shape exemplified in FIGS. 2A to 2D has two side surfaces (101, 102), a marginal part (where dough sheet is folded to join in an overlap) 103, a bottom surface 104, and two ends (105, 106) on the opposite sides in the longitudinal direction. Gyoza dumpling baked on cooking utensils such as frying pan has a burn mark on the bottom surface 104. The bottom surface is also called a “baking surface” since it a surface to be imparted with a burn mark. These names such as “bottom surface” and “side surface” are used to explain each part of gyoza dumpling and do not limit the position or posture of the gyoza dumpling. For example, baked gyoza dumpling is generally placed on a dish with the bottom surface having a burn mark facing up.

The outer peripheral edge of the bottom surface of the frozen gyoza dumpling 100 is an outline defining the shape (outer circumference shape) of the bottom surface. The bottom surface of the gyoza dumpling is a surface in contact with the flat surface when the gyoza dumpling is set on the flat surface with the bottom surface facing down. In the actual gyoza dumpling, the bottom surface and both side surfaces are smoothly connected with a roundly curved surface, and often lack a clear outline.

While the shape of the bottom surface of the frozen gyoza dumpling 100 is often like a crescent as shown in FIG. 2C, it is not always necessary to be curved, and may be half-moon, streamline-shaped, or have various creative shapes.

The size of the frozen gyoza dumpling 100, material, thickness, size and shape, (generally a circular shape) of dough, and components, constitution, amount, and cooking method of filling, which are used for manufacture of gyoza dumpling before freezing, are not particularly limited, manufacture method of filling and dough, wrapping manner and the like can be those known to one of ordinary skill in the art.

In one embodiment, in a frozen gyoza dumpling 100 having a shape shown in FIG. 2A, the distance between both ends 105 and 106 of the bottom surface of the gyoza dumpling shown in FIG. 2C is about 25 mm to 110 mm, and the width of the bottom surface at the widest center part is often about 10 mm to 40 mm. The height of the gyoza dumpling (distance between the top of the marginal part 103 and the bottom surface 104 in FIG. 2D) is about 15 mm to 40 mm. The weight of one frozen gyoza dumpling 100 is about 10 g to 45 g. These numerical ranges are those of general embodiments and do not limit the present invention.

The frozen gyoza dumpling 100 may be obtained by freezing the dumpling in a state where the filling is wrapped with dough (raw gyoza dumpling), may be subjected to a preliminary heat treatment such as steaming and boiling or a necessary treatment before freezing, and the state of the gyoza dumpling before freezing is not particularly limited.

To sterilize the product, it is preferable to perform a preliminary heat treatment before freezing. For example, a batter liquid and gyoza dumplings are stored in a tray, and may be heated and steamed at about 60° C. to 100° C. Also, gyoza dumplings heated and steamed at about 60° C. to 100° C. may be set in a tray and then a batter liquid may be injected, or a batter liquid may be injected in a tray and then gyoza dumplings heated and steamed at about 60° C. to 100° C. may be set. In this case, the batter liquid may or may not be heated in advance. The aforementioned temperature range is one example, and the heating temperature and heating time can be appropriately changed according to the size and weight of gyoza dumpling itself, weight ratio of filling, mixing ratio of meat and vegetable in the filling and the like.

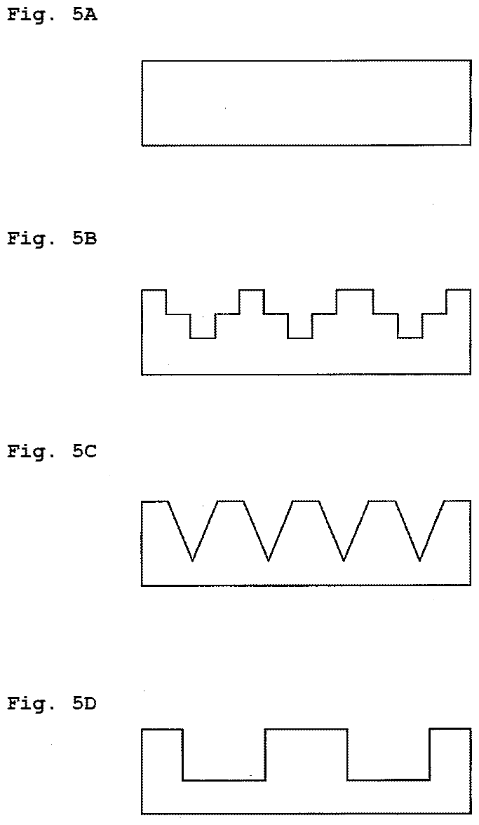

The lower side in the longitudinal direction of the part connected by frozen batter 200 is a straight line in FIG. 1C but may have undulations. In the present specification, “have undulations” means not being flat. For example, the lower side in the longitudinal direction of the part connected by frozen batter 200 may have a shape that bites into the cross-sectional shape (e.g., the top surface has convexes and concaves (FIG. 5B), the top surface has peaks and valleys (FIG. 5C), the top surface has large grooves (Fig.

The size of the part connected by frozen batter 200 is not particularly limited, and the length in the longitudinal direction is preferably 25 mm to 120 mm, the length in the short side direction is preferably 0.5 mm to 50 mm, and the height is preferably 0.5 mm to 50 mm.

When the lower side in the longitudinal direction of the part connected by frozen batter 200 has undulations, the size of the undulations is appropriately determined by the size of the partitioning protrusion 330 in the tray of the present invention shown in, for example, FIG. 5B to FIG. 5D explained below.

In the frozen gyoza dumplings of the present invention, only one frozen gyoza dumpling 100 is preferably present in a cuboid with a long side length L, a short side length S, and a height H, wherein L is a length the longitudinal direction, S is a length in the short side direction, and H is a height of the frozen gyoza dumpling 100.

In this case, the marginal part of the adjacent gyoza dumpling does not enter into the cuboid and cracking of the marginal part can be prevented when dividing the connected frozen gyoza dumplings 100.

In the frozen gyoza dumplings of the present invention, the number of frozen gyoza dumplings 100 to be connected is not particularly limited. Considering the operability when taking out from the tray at home and the number of gyoza dumplings to be eaten at one time, it is preferable to connect 2 to 6 gyoza dumplings vertically and arrange same in one to three rows. When designing for a commercial gyoza dumpling grilling machine, it is preferable to connect 5 to 12 gyoza dumplings vertically and arrange same in 1 or 2 rows.

FIGS. 1A to 1F show an example of arranging 4 frozen gyoza dumplings 100 in one row. They may be arranged in two or more rows as described above according to the number of supplies.

In the frozen gyoza dumplings of the present invention, the batter liquid constituting the frozen batter 200 (hereinafter also simply referred to as “batter liquid”) contains water, fats and oils and an emulsifier, and further contains one or more selected from grain flour, starch, and protein.

The batter liquid preferably a mixture of 10 to 95% (% by weight, hereinafter the same) of water and oils and fats added thereto. By attaching the frozen batter 200 obtained by freezing this batter liquid to the frozen gyoza dumplings 100 at a rate of 10 to 40 parts by weight with respect to 100 parts by weight of the frozen gyoza dumplings, when the frozen gyoza dumplings 100 are cooked on cooking utensils such as a frying pan, the frozen batter 200 melts and the moisture evaporates, which in turn places the frozen gyoza dumplings 100 in an appropriate steamed state. The frozen batter 200 may or may not attach to the bottom surface of the frozen gyoza dumplings 100. From the viewpoint of imparting a favorable browning color to the bottom surface of the gyoza dumplings when cooked, the frozen batter 200 is preferably attached to the bottom surface of the frozen gyoza dumplings 100. When the amount of water in the frozen batter 200 with respect to a frozen gyoza dumpling 100 is too small, a sufficient steam-baked state cannot be ensured during the above-mentioned heating cooking, and the texture of surrounding dough may be impaired, and the finish of baking may become uneven. In contrast, when the amount is too high, the filling is sometimes overheated, and the surrounding dough may have a weak chewiness. Therefore, the amount of the frozen batter 200 with respect to a frozen gyoza dumpling 100 is determined according to the blending ratio of the frozen batter 200 (particularly the amount of water). The amount is preferably 10 to 40 parts by weight, more preferably 18 to 30 parts by weight, further preferably 24 to 30 parts by weight, with respect to 100 parts by weight of a frozen gyoza dumpling 100.

The water content of frozen batter 200 is 10 to 95 wt %, preferably 50 to 90 wt %, further preferably 60 to 05 wt %. When the water content of the frozen batter 200 is small, a large amount of oil remains when the gyoza dumplings are taken out from cooking utensils such as a frying pan after cooking and the seam of dough of the gyoza dumpling tends to be hard. When the water content of the frozen batter 200 is higher, the crunchy feeling of vegetables in the filling tends to be weak.

Since the batter liquid contains fat and/or oil, unevenness in baking gyoza dumplings does not occur easily even without using oil during cooking. When the batter liquid does not contain fat and/or oil, the bottom surface of gyoza dumplings is easily burnt during cooking, and detachment of the gyoza dumplings from cooking utensils such as frying pan tends to be difficult. The content of fat and/or oil in the batter liquid is 2 to 90 wt %, preferably 3 to 50 wt %, more preferably 5 to 30 wt %.

When the content of fats and oils in the frozen batter 200 is low, the release property during taking out the cooked gyoza dumplings from cooking utensils such as a frying pan tends to become poor. When the content of fats and oils in the frozen batter 200 is high, the strength of the batter decreases and, since fats and oils are softer than water even when frozen, the batter tends to remain on the tray when the frozen gyoza dumplings are taken out from the tray, and the connected frozen gyoza dumplings 100 may be damaged during transportation, making it difficult to maintain the connected state.

While the fat and/or oil are/is not particularly limited, rapeseed oil, canola oil, soybean oil, corn oil, safflower oil, palm oil, lard, shortening, butter, sesame oil, olive oil and the like can be used alone or in combination. In addition, transesterified oils obtained by esterifying these oils and fats, hydrogenated oils obtained by hydrogenating these oils and fats, and the like can also be used. Particularly, rapeseed oil, canola oil, and soybean oil are preferred.

As the emulsifier, lecithin (derived from soybean, derived from egg etc.), enzymatically decomposed lecithin, sugar ester, monoglyceride, polyglycerol ester of fatty acid, propylene glycol ester of fatty acid and the like can be used, and particularly, lecithin is preferable, and lecithin derived from soybean is more preferred.

While the content of the emulsifier in a batter liquid is not particularly limited, it is generally 0.1 to 3.0 wt %, preferably 0.15 to 1.5 wt %, further preferably 0.15 to 1 wt %. Using an emulsifier, the batter liquid comes to have an emulsified state, which affords uniform property of the batter liquid, and suppresses unevenness in baking of gyoza dumpling after baking, whereby uniform, preferable texture and appearance can be conferred to a gyoza dumpling.

The batter liquid may contain starch or grain flour.

The starch is not particularly limited and, for example, unmodified starch (raw starch) that has not been processed (physical treatment, chemical treatment, enzymatic treatment) may be used. As the raw starch, for example, non-glutinous rice starch, glutinous rice starch, wheat starch, corn starch, waxy corn starch, tapioca starch, sago starch, mung bean starch, potato starch, sweet potato starch, and the like may be used. In addition, modified starches obtained by a processing treatment of raw starches may also be used. As used herein, the “modified starch” refers to starch subjected to at least one processing treatment selected from the group consisting of a physical treatment, a chemical treatment, and an enzymatic treatment. Specific examples of the starch subjected to a physical treatment (including simple chemical treatments of the level of hydrolysis such as acid treatment, alkaline treatment, bleaching treatment and the like) include pregelatinized starch, heat-moisture treated starch, oil coated starch, acid-treated starch, alkaline treated starch, bleached starch and the like. Specific examples of the starch subjected to a chemical treatment include acetylated distarch adipate, acetylated distarch phosphate, acetylated oxidized starch, starch sodium octenylsuccinate, starch acetate, oxidized starch, hydroxypropyl starch, hydroxypropyl distarch phosphate, phosphated distarch phosphate, monostarch phosphate, distarch phosphate, sodium starch glycolate, and the like. Specific examples of the starch subjected to an enzyme treatment include enzyme-treated starch and the like. One kind of starch (e.g., raw starches such as corn starch, waxy corn starch, and the like; modified starches such as phosphoric acid crosslinking tapioca starch, and the like) may be used alone, or two or more kinds thereof may be used in combination. Particularly, non-glutinous rice starch and glutinous rice starch, and modified starch thereof are preferred. While the grain flour is not particularly limited, wheat flour, rice flour, corn flour, barley flour, buckwheat flour, potato flour, soybean flour, adzuki bean flour, barnyard millet flour, chestnut flour, millet flour and the like can be used. Particularly, rice flour is preferred since it can easily confer a crispy texture after baking.

A protein may be blended in the batter liquid. The protein includes soybean protein, wheat protein, pea protein, milk protein, and eggs (whole egg, egg yolk, egg white), and soybean protein and egg white are preferred.

The batter liquid may further contain emulsifying aids, soy sauce, salts, saccharides, amino acids, gums, celluloses, and the like.

The batter liquid may be heated or unheated. Also, the batter liquid may or may not be emulsified.

The frozen gyoza dumplings of the present invention may be provided in a trays or provided in an outer packaging bag or the like instead of a tray.

The tray of the present invention is now explained.

The tray of the present invention has an inner shape most preferable and suitable for storing the frozen gyoza dumplings in the present invention. It aims to produce the frozen gyoza dumplings of the present invention, and may store frozen gyoza dumplings other than the frozen gyoza dumplings of the present invention.

In the following explanation, a preferred embodiment for the frozen gyoza dumplings of the present invention is explained.

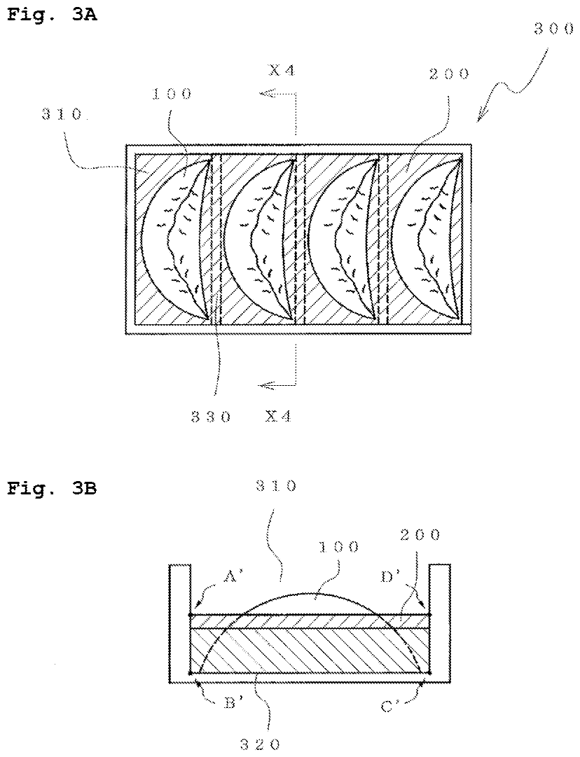

As exemplarily shown in FIGS. 3A and 3B, the tray 300 is for storing frozen gyoza dumplings (a plurality of frozen dumplings 100 is connected by frozen batter 200). The tray 300 has a plurality of receiving parts 310 inside for individually arranging a plurality of frozen gyoza dumplings 100. Each receiving part 310 has a supporting surface 320 for supporting the frozen gyoza dumplings 100 with the lower surface facing downward. While the side wall of the receiving part 310 vertically stands in FIG. 3B, it may inclined with respect to the vertical direction.

The frozen gyoza dumplings of the present invention can be obtained merely injecting a batter liquid up to a given height in the tray 300, arranging unfrozen gyoza dumplings or frozen gyoza dumplings 100 on a supporting surface, applying preliminary heating as necessary, and then freezing them.

The frozen gyoza dumplings of the present invention may also be obtained by arranging unfrozen gyoza dumplings or frozen gyoza dumplings 100 on a supporting surface of the tray 300, injecting a batter liquid up to a given height in the tray 300, applying preliminary heat as necessary, and then freezing them.

Furthermore, for the purpose of preventing drying, water may be injected after injecting a batter liquid up to a given height in the tray 300 and arranging unfrozen gyoza dumplings or frozen gyoza dumplings on a supporting surface.

The preliminary heating may be performed in a state in which unfrozen gyoza dumplings or frozen gyoza dumplings, and a batter liquid are contained in the tray 300. In this case, superior productivity and superior hygiene are afforded because the gyoza dumplings and the batter liquid can be simultaneously heated.

The preliminary heating may also be performed only on unfrozen gyoza dumplings or frozen gyoza dumplings 100. In this case, even though hygiene may be inferior, since the batter liquid is not heated, the grain flour and starch blended in the batter liquid do not gelatinize or thicken, which in turn allows the batter liquid to spread more easily than when using a heated batter and to form a good wing, when cooking the frozen gyoza dumplings of the present invention on cooking utensils such as a frying pan.

The shape of the bottom surface of the frozen gyoza dumpling 100 is generally a shape having a longitudinal direction as shown in FIG. 2C. The shape of the actual bottom surface is not a simple shape and has a comparatively large manufacturing error as a food. The shape of the supporting surface 320 is not particularly limited as long as it can support the bottom surface.

The plurality of receiving parts 310 is arranged in one or more rows while being divided by a partitioning protrusion 330.

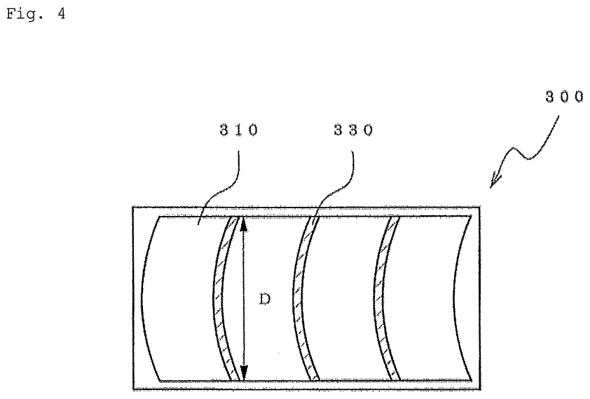

The shape of the partitioning protrusion 330 is not particularly limited and may be a flat plane as shown in FIG. 3A or a curved surface as shown in FIG. 4 according to the shape of the frozen gyoza dumplings 100 to be stored. To store gyoza dumplings in a smaller space, a flat plane is preferred when the gyoza dumplings have a shape that is not curved, and a curved plane is preferred when the gyoza dumplings have a curved shape. The height of the both ends of the partitioning protrusion 330 in the longitudinal direction is preferably the same as or higher than a height of other parts of the partitioning protrusion. This is because when the partition of this part is lower than the other parts, both ends of the marginal part of the gyoza dumpling, which generally has a crescent shape, easily enter another receiving part. When both ends of the marginal part enter another receiving part, the marginal part is easily cracked when dividing two connected frozen gyoza dumplings 100, and the appearance quality is impaired.

The sectional shape of the partitioning protrusion 330 is not particularly limited. For example, it may be a simple rectangle (FIG. 5A), one having a top surface with undulations (e.g., one having a top surface with convexes and concaves (FIG. 5B), one having a top surface with peaks and valleys (FIG. 5C), one having a top surface with large grooves (FIG. 5D), etc.). As the batter liquid increases in volume due to freezing, it easily bites into the tray, making it difficult to take out the gyoza dumplings. Therefore, the top surface of the partitioning protrusion 330 preferably has convexes and concaves, and the convexes and concaves are more preferably tapered in the direction of from the top surface to the bottom surface. When the partitioning projection 330 has a curved surface as shown in FIG. 4, the “sectional shape of the partitioning protrusion 330” in the present specification refers to the shape of the section of the curved surface developed into a flat plane.

The size of the partitioning protrusion 330 is not particularly limited, and the length in the longitudinal direction is preferably 25 mm to 120 mm, the length in the short side direction is preferably 0.5 mm to 50 mm, and the height is preferably 0.5 mm. to 50 mm.

For example, as shown in FIG. 5B to FIG. 5D, when the partitioning protrusion 330 has undulations, the size of the undulations is appropriately determined such that an area of the part connected by the frozen batter liquid 200 and an area of other parts in quadrangle A′B′C′D′ is preferably 1:5.5 to 1:28, more preferably 1:6 to 1:20, further preferably 1:7 to 1:12.

In the tray 300 of the present invention, when frozen gyoza dumplings a plurality of frozen gyoza dumplings 100 connected by a frozen batter are stored, a plurality of receiving parts 310 can store the plurality or connected frozen gyoza dumplings 100 such that a ratio of an area of the part connected by the frozen batter liquid 200 (a part with hatching from upper right to lower left in FIG. 3B) and an area of other parts (a part with hatching from upper left to lower right) in quadrangle A′B′C′D′ is preferably 1:5.5 to 1:28, more preferably 1:6 to 1:20, further preferably 1:7 to 1:12, in (i) or (ii) below:
when adjacent frozen gyoza dumplings 100 are cut along the longitudinal direction of the partitioning protrusion 300,
(i) a quadrangle A′B′C′D′ in a sectional view (e.g., X4-X4 sectional arrow view of FIG. 3B) when the cutting plane is a flat plane (that is, when partitioning protrusion 330 is a flat plane as shown in FIGS. 3A and 3B), wherein A′ and D′ are respectively the both ends of the frozen batter 200 at the height thereof and at the inner side of the side wall of the receiving part 310 in the sectional view, B′ is one of the both ends of the supporting surface 320 in the longitudinal direction which is closer to A′ in the horizontal direction, and C′ is the other end closer to D′ in the horizontal direction (typically rectangle as shown in FIG. 3B, but other quadrangles including trapezoid, inverted trapozid, and parallelogram are not excluded),
(ii) a quadrangle A′B′C′D′ in a sectional view created by developing the cutting plane on a flat plane when the cutting plane is a curved surface (that is, when partitioning protrusion 330 is a curved surface as shown in FIG. 4), wherein A′ and D′ are respectively the both ends of the frozen batter 200 at the height thereof and at the inner side of the side wall of the receiving part 310 in the sectional view, B′ is one of the both ends of the supporting surface 320 in the longitudinal direction which is closer to A′ in the horizontal direction, and C′ is the other end closer to D′ in the horizontal direction.

As a method for developing a curved surface into a flat plane, developable surfaces such as a cylindrical surface or a conical surface can be simply developed into a flat surface since such curved surface was created by curving the original straight sides. In the case of non-developable surfaces such as a spherical surface, for example, the least-squares method is used to create an approximate developable surface and the surface is developed.

When the above-mentioned ratio is greater than the above-mentioned range, it becomes difficult to divide the plural frozen gyoza dumplings 100 into a required number. When such ratio is smaller than the above-mentioned range, for example, it becomes difficult to take out plural frozen gyoza dumplings 100 in a connected state.

FIG. 3A, FIG. 3B, and FIG. 4 show one example of the tray of the present invention. The shape of each part of the tray shown in these Figures is one example of the embodiment along the technical concept of the present invention, and does not limit the shape of the tray. In the examples shown in these Figures, four frozen gyoza dumplings 100 are received in one tray, and the outer shape and number of the frozen gyoza dumplings 100 to be received are not limited.

As exemplified in FIG. 3A and FIG. 4, when a plurality of frozen gyoza dumplings 100 is received in the tray, a necessary number of supporting surfaces (four in the examples of the Figures) are formed in the tray.

In the example of FIG. 4, a preferred embodiment includes supporting surfaces facing the same direction, divided by partitioning protrusions 330, and disposed in one row. In the examples of FIG. 3A, FIG. 3B, and FIG. 4, four frozen gyoza dumplings 100 are configured in one row. For example, a configuration pattern according to the number to be supplied may be employed, such as a pattern of three rows of five frozen gyoza dumplings 100 as one row and a pattern of four rows of six frozen gyoza dumplings 100 as one row. In addition, plural supporting surfaces may each face a different direction.

The size, material, molding method, and thickness of each part such as wall and the like of the tray 300 of the present invention are not particularly limited, and conventionally-known trays for frozen gyoza dumplings can be referred to. Examples of the material include plastic such as vinyl chloride, polyethylene terephthalate, polystyrene, polypropylene, polycarbonate and the like, metals such as aluminum and the like, paper and the like, and examples of the molding method include injection molding, blow molding, vacuum forming, pressure forming and the like. While the thickness of each part varies depending on the rigidity of the material and function of the part, it is, for example, about 0.1 mm-2.0 mm.

The pack of the present invention is now explained.

The pack of the present invention has a constitution in which a plurality of frozen dumplings 100 connected by frozen batter 200 is arranged in the above-mentioned tray 300 of the present invention.

The tray 300 of the present invention containing frozen gyoza dumplings arranged therein is preferably sealed tightly. The manner in which the tray 300 is sealed includes, for example, a manner in which the opening of the tray 300 of the present invention is tightly sealed with a top seal film or the like, a manner in which the pack is tightly sealed in an outer package bag or the like by various pillow packagings, a combination of these, and the like. Hermetical sealing is preferred from the viewpoint of hygiene and suppression of quality deterioration such as freezer burn, fading, oxidation of fats and oils and the like that occurs during frozen storage.

Finally, the production method of the present invention is explained below.

In the production method of the present invention, the tray of the present invention 300 is used and the following steps S1 and S2 are involved.
(step S1) A step of contacting a plurality of unfrozen gyoza dumplings (raw gyoza dumplings with fillings wrapped with dough) with the lower surface facing downward, with a batter liquid so as to satisfy the following condition (I):
   (I) in the frozen gyoza dumplings obtained in step S2, a ratio of an area of the part connected by the frozen batter liquid and an area of other parts in quadrangle A′B′C′D′ is preferably 1:5.5 to 1:28, more preferably 1:6 to 1:20, further preferably 1:7 to 1:12, in (i) or (ii) below:
      when adjacent frozen gyoza dumplings 100 are cut along the longitudinal direction of the partitioning protrusion 300,
(i) a quadrangle A′B′C′D′ in a sectional view when the cutting plane is a flat plane, wherein A′ and D′ are respectively the both ends of the frozen batter 200 at the height thereof and at the inner side of the side wall of the receiving part 310 in the sectional view, B′ is one of the both ends of the supporting surface 320 in the longitudinal direction which is closer to A′ in the horizontal direction, and C′ is the other end closer to D′ in the horizontal direction,
(ii) a quadrangle A′B′C′D′ in a sectional view created by developing the cutting plane on a flat plane when the cutting plane is a curved surface, wherein A′ and D′ are respectively the both ends of the frozen batter 200 at the height thereof and at the inner side of the side wall of the receiving part 310 in the sectional view, B′ is one of the both ends of the supporting surface 320 in the longitudinal direction which is closer to A′ in the horizontal direction, and C′ is the other end closer to D′ in the horizontal direction.

As a method for developing a curved surface into a flat plane, developable surfaces such as a cylindrical surface or a conical surface can be simply developed into a flat surface since such curved surface was created by curving the original straight sides. In the case of non-developable surfaces such as a spherical surface, for example, the least-squares method is used to create an approximate developable surface and the surface is developed.
(step S2) A step of freezing a plurality of unfrozen gyoza dumplings or frozen gyoza dumplings 100 and a batter liquid in the state obtained in step S1, there by obtaining frozen gyoza dumplings composed of a plurality of frozen gyoza dumplings 100 connected by the frozen batter. Before freezing, the gyoza dumplings may be appropriately subjected to the above-mentioned preliminary heat treatments such as steaming and boiling, or a treatment according to a need.

In the above-mentioned step S1, the batter liquid may be injected into the tray before or after storing the gyoza dumplings in the tray, as described above. Alternatively, the batter liquid may be injected into the tray, the gyoza dumplings may be thereafter stored in the tray, and water may be further injected into the tray.

Furthermore, in the above-mentioned step S1, a method of integrating the batter liquid with the bottom surface of the unfrozen or frozen gyoza dumpling 100 in a frozen state while satisfying the above-mentioned condition (I) may be any and, for example, a method using a die for positioning the batter liquid on the gyoza dumpling itself, a method including applying a batter liquid having increased viscosity by cooling to the gyoza dumpling or the like can be used.

Utilizing the tray of the present invention and sequentially performing the above-mentioned steps S1 and S2 in the tray, the frozen gyoza dumpling of the present invention can be completed while being contained in the tray and can be directly sent to a packaging step.

In a production method utilizing the tray, the above-mentioned step S1 is preferably performed by including the following steps.
(step S11) A filling is wrapped with dough by a general procedure to form an unfrozen gyoza dumpling (raw gyoza dumpling) or frozen gyoza dumpling 100.
(Step S12) A separately-formed tray is filled with a batter liquid.
(step S13) The bottom surface of the unfrozen gyoza dumpling or frozen gyoza dumpling 100 facing downward is configured on each receiving part of the tray.

Here, either of the step S12 for injecting the batter liquid into the tray and step S13 for disposing an unfrozen gyoza dumpling or a frozen gyoza dumpling 100 in the tray may be performed earlier.

Where necessary, a preliminary heat treatment and the like may be appropriately applied to gyoza dumplings and batter before freezing, as mentioned above.

Then, in the above-mentioned step S2, a plurality of unfrozen gyoza dumplings or frozen gyoza dumplings 100 attached with the batter liquid in the tray is rapidly frozen together with the tray, in which a plurality of unfrozen gyoza dumplings or frozen gyoza dumplings 100 and the batter liquid are frozen in a state of being attached together, whereby the frozen gyoza dumplings of the present invention are obtained.

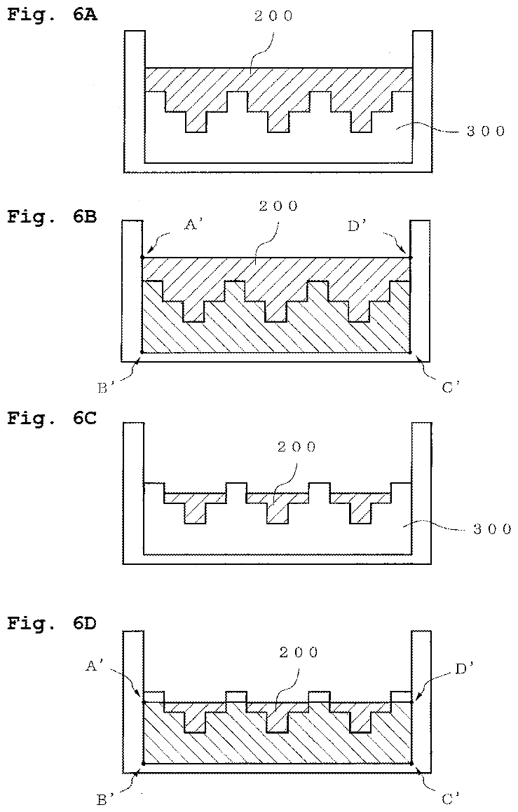

For example, when partitioning protrusion 330 having the shape shown in FIG. 5B is used and when the amount of the batter liquid to be injected is large (FIG. 6A), the quadrangle A′B′C′D′ becomes as shown in FIG. 6B. When the amount of the batter liquid to be injected is small, the quadrangle A′B′C′D′ becomes as shown in FIG. 6D.

When the frozen gyoza dumplings of the present invention are produced by the production method of the present invention, quadrangle A′B′C′D′ in the tray 300 of the present invention, and the quadrangle ABCD of the frozen gyoza dumplings of the present invention have the same area.

Other features of the invention will become apparent in the course of the following descriptions of exemplary embodiments which are given for illustration of the invention and are not intended to be limiting thereof.

### EXAMPLES

### [Preparation of Gyoza Dumpling Itself]

A filling (13.2 g) from a total mixture (32 g) of meat (mixture of ground pork and ground chicken, 260 g), vegetables (mixture of cabbage, onion, Chinese chive, garlic, 550 g), egg white (25 g), sesame oil (20 g), sake (10 g), spice and seasoning, which has a water content of about 68%, was wrapped with one sheet of commercially available gyoza dumpling dough (5.6 g) to give a raw gyoza dumpling (unfrozen gyoza dumpling itself) having a total weight of about 19 g.

### [Preparation of Batter Liquid]

An emulsified batter liquid containing water 84 wt %, canola oil 13 wt %, rice flour 2.5 wt %, an emulsifier (lecithin derived from soybean, 0.1 wt %), and emulsifying aids 0.4 wt % (egg white powder) was prepared.

### [Tray Formation]

A tray with the following parameters was formed.
tray for 12 dumplings (4 connected dumplings×3 rows)
material: polypropylene
outer size: short side direction length 128 mm×longitudinal direction length 235 mm×height 34 mm
bottom size of receiving part: short side direction length 22.5 mm×longitudinal direction length 67.5 mm
bottom size of partitioning protrusion: short side direction length 5 mm×longitudinal direction length 67.5 mm

As used herein, the “longitudinal direction length” in the sizing of the receiving part and the sizing of the partitioning protrusion refers to the length of the straight line distance, and when the partitioning projection is flat, it is the actual size. When the partitioning projection is a curved surface, it refers to D in FIG. 4. In Examples 1 to 4 and Comparative Example 1 in the following Examples and Comparative Examples, the partitioning protrusion is a curved surface in the shape of a circular arc (width 5 mm) with a longitudinal linear distance (chord length) of 67.5 mm and an R (radius) of 80 mm in a plan view, and the longitudinal length (arc length) when this is developed on a flat plane is 69.7 mm. In Table 2 and Table 4 showing various parameters of Examples 1 to 4 and Comparative Example 1, the schematic diagrams of cross sections of the partitioning protrusions are those after the curved surface is developed on a flat plane.

### [Attachment of Batter Liquid]

The batter liquid was poured into the tray, unfrozen gyoza dumplings or frozen gyoza dumplings 100 were placed with the bottom surface facing down, on the supporting surface of the tray receiving part, preliminary heating was performed, and they were rapidly frozen to give frozen gyoza dumplings.

The weight of the frozen batter 200 attached to one frozen gyoza dumpling 100 is 4.5 g. That is, about 28 parts by weight of the frozen batter 200 attaches to 100 parts by weight of the frozen gyoza dumpling 100.

In the following Examples and Comparative Examples, frozen gyoza dumplings were actually produced and the quality thereof was evaluated.

The evaluation items were (a) whether subdivision is possible and (b) whether taking out while connected is possible.

Here, (a) whether subdivision is possible means whether or not four frozen gyoza dumplings 100 can be divided into an arbitrary number.

In addition, (b) whether taking out while connected is possible means whether four frozen gyoza dumplings 100 can be taken out in a connected state. The evaluation criteria for (a) and (b) are shown in Table 1.

◯ and Δ are acceptable in any evaluation.

TABLE 1
(a) whether subdivision is possible

| evaluation | evaluation criteria |
|---|---|
| ○ | easily divided into any number |
| Δ | easily divided at center (divided into two each), |
| | but rather difficult to divide at end (divided |
| | into 1 and 3). Marginal part is cracked |
| | somewhat. |
| × | cannot be divided, marginal part is markedly |
| | cracked |

(b) whether taking out while connected is possible

| evaluation | evaluation criteria |
|---|---|
| ○ | easily taken out |
| Δ | can be taken out |
| × | connected and cannot be taken out |

### Example 1 and 2 and Comparative Example 1

According to the parameters shown in Table 2, a tray having partitioning protrusions with a top surface having convexes and concaves was formed, frozen gyoza dumplings were actually produced using the tray and the quality thereof was evaluated. The results are shown in Table 3.

TABLE 3

| | (a) | (b) | |
|---|---|---|---|
| | whether | whether taking out | |
| | subdivision | while connected is | |
| | is possible | possible | Note |
| Example 1 | ○ | ○ | |
| Example 2 | ○ | Δ | |
| Comparative | ○ | × | breaks uninten- |
| Example 1 | | | tionally |

### Examples 3 and 4

According to the parameters shown in Table 4, a tray having partitioning protrusions with a top surface having peaks and valleys was formed. Using the tray, frozen gyoza dumplings were actually produced, and the quality of the frozen gyoza dumplings was evaluated. The evaluation results are shown in Table 5.

TABLE 5

| | | (b) | |
|---|---|---|---|
| | (a) | whether taking | |
| | whether | out while | |
| | subdivision | connected is | |
| | is possible | possible | Note |
| Example | ◯ | ◯ | partitioning of end of |
| 3 | | | gyoza dumpling is |
| | | | important |
| | | | (dough must not enter |
| | | | another partitioning) |
| Example | ◯ | ◯ | |
| 4 | | | |

### Comparative Examples 2 and 3, and Example 5

According to the parameters shown in Table 6, a tray having partitioning protrusions with a flat top surface was formed. Using the tray, frozen gyoza dumplings were actually produced, and the quality of the frozen gyoza dumplings was evaluated. The evaluation results are shown in Table 7.

TABLE 7

| | | (b) | |
|---|---|---|---|
| | | whether | |
| | (a) | taking out | |
| | whether | while | |
| | subdivision | connected | |
| | is possible | is possible | Note |
| Comparative | × | ○ | dough of top of marginal |
| Example 2 | | | part cracks when dividing |
| | | | gyoza dumplings |
| Comparative | × − Δ | ○ | four dumplings can be |
| Example 3 | | | divided into two each, |
| | | | but two dumplings cannot |
| | | | be divided into one each |
| Example 5 | ○ | ○ | |

### Example 6 and Example 7

According to the parameters shown in Table 8, a tray having partitioning protrusions with a top surface having large grooves was formed. Using the tray, frozen gyoza dumplings were actually produced, and the quality of the frozen gyoza dumplings was evaluated. The evaluation results are shown in Table 9.

TABLE 9

| | | (b) | |
|---|---|---|---|
| | (a) | whether taking | |
| | whether | out while | |
| | subdivision | connected is | |
| | is possible | possible | Note |
| Example | ○ | ○ | |
| 6 | | | |
| Example | Δ | ○ | both ends of marginal |
| 7 | | | part crack easily because |
| | | | both ends of partitioning |
| | | | protrusion are open |

### INDUSTRIAL APPLICABILITY

According to the frozen gyoza dumplings of the present invention, gyoza dumplings in a frozen state can be easily divided into the required number and can be easily taken out in a connected state from a tray.

The tray of the present invention can preferably provide the frozen gyoza dumpling and the pack of the present invention, and the manufacture method of the present invention can be preferably practiced.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. Frozen gyoza dumplings comprising a plurality of frozen gyoza dumplings connected by a frozen batter, wherein
a cutting plane formed by separating adjacent frozen gyoza dumplings by cutting at a part where they are connected by a frozen batter is a cutting plane (1), a plane parallel to the cutting plane (1) and formed by cutting the frozen gyoza dumpling along a plane passing through the center of a marginal part of the frozen gyoza dumpling is a cutting plane (2),
(i) when the cutting plane (1) and the cutting plane (2) are flat planes, an area of the part connected by the frozen batter in the cutting plane (1) is P, both ends of an upper side of the frozen batter in the longitudinal direction in the cutting plane (2) are respectively A and D, one of the both ends of the bottom surface of the frozen gyoza dumpling, or one of the both ends of the frozen batter at the same height as the bottom surface of the frozen gyoza dumpling, or one of the both ends at the lower side of the frozen batter beneath and attached to the bottom surface of the frozen gyoza dumpling, which is closer to A in the horizontal direction, is B and the other end closer to D in the horizontal direction is C, and an area of a quadrangle formed by ABCD is Q,
(ii) when the cutting plane (1) and the cutting plane (2) are curved surfaces, an area of the part connected by the frozen batter in a cutting plane created by developing the cutting plane (1) on a flat plane is P, both ends of an upper side of the frozen batter in the longitudinal direction in a cutting plane created by developing the cutting plane (2) on a flat plane are respectively A and D, one of the both ends of the bottom surface of the frozen gyoza dumpling, or one of the both ends of the frozen batter at the same height as the bottom surface of the frozen gyoza dumpling, or one of the both ends at the lower side of the frozen batter beneath and attached to the bottom surface of the frozen gyoza dumpling, which is closer to A in the horizontal direction, is B and the other end closer to D in the horizontal direction is C, and an area of a quadrangle formed by ABCD is Q, and
P:(Q-P) is 1:5.5 to 1:28.

2. The frozen gyoza dumplings according to claim 1, wherein a lower side in the longitudinal direction of the part connected by the frozen batter has undulations.

3. The frozen gyoza dumplings according to claim 1 or 2, wherein only one frozen gyoza dumpling is placed in a cuboid with a long side length L, a short side length S, and a height H, wherein L is a length in the longitudinal direction, S is a length in the short side direction, and H is a height of the frozen gyoza dumpling.

4. The frozen gyoza dumplings according to any one of claims 1 to 3, wherein the frozen batter consists of a batter liquid comprising water, fats and oils, and an emulsifier, and further comprising one or more selected from grain flour, starch, and protein.

5. The frozen gyoza dumplings according to any one of claims 1 to 4, which are stored in a tray.

6. Frozen gyoza dumplings stored in a tray, wherein
the tray comprises a plurality of receiving parts for individually placing a plurality of frozen gyoza dumplings,
the plural receiving parts are connected with a partitioning protrusion set between respective receiving parts, and form one or more rows, and
a ratio of an area of the part connected by the frozen batter and an area of other part is 1:5.5 to 1:28 in (i) or (ii) below:
when adjacent frozen gyoza dumplings are cut along the longitudinal direction of the partitioning protrusion,
(i) a quadrangle A′B′C′D′ in a sectional view when the cutting plane is a flat plane, wherein A′ and D′ are respectively the both ends of the frozen batter at the height thereof and at the inner side of the side wall of the receiving part in the sectional view, B′ is one of the both ends of the supporting surface in the longitudinal direction which is closer to A′ in the horizontal direction, and C′ is the other end closer to D′ in the horizontal direction,
(ii) a quadrangle A′B′C′D′ in a sectional view created by developing the cutting plane on a flat plane when the cutting plane is a curved surface, wherein A′ and D′ are respectively the both ends of the frozen batter at the height thereof and at the inner side of the side wall of the receiving part in the sectional view, B′ is one of the both ends of the supporting surface in the longitudinal direction which is closer to A′ in the horizontal direction, and C′ is the other end closer to D′ in the horizontal direction.

7. The frozen gyoza dumplings according to claim 6, wherein the gyoza dumplings are stored in a tray with partitioning protrusions whose top surface has undulations.

8. The frozen gyoza dumplings according to claim 6 or 7, wherein the gyoza dumplings are stored in a tray in which a height of the both ends of the partitioning protrusion in the longitudinal direction is the same as or higher than a height of other parts of the partitioning protrusion.

9. A tray for storing frozen gyoza dumplings consisting of a plurality of frozen gyoza dumplings connected by a frozen batter, the tray comprising a plurality of receiving parts for individually placing a plurality of frozen gyoza dumplings, wherein
the plural receiving parts are connected with a partitioning protrusion set between respective receiving parts, and form one or more rows, and
when the frozen gyoza dumplings consisting of a plurality of frozen gyoza dumplings connected by the frozen batter are stored, the plural receiving parts store the plurality of connected frozen gyoza dumplings such that a ratio of an area of the part connected by the frozen batter and an area of other part is 1:5.5 to 1:28 in (i) or (ii) below:
when adjacent frozen gyoza dumplings are cut along the longitudinal direction of the partitioning protrusion,
(i) a quadrangle A′B′C′D′ in a sectional view when the cutting plane is a flat plane, wherein A′ and D′ are respectively the both ends of the frozen batter at the height thereof and at the inner side of the side wall of the receiving part in the sectional view, B′ is one of the both ends of the supporting surface in the longitudinal direction which is closer to A′ in the horizontal direction, and C′ is the other end closer to D′ in the horizontal direction,
(ii) a quadrangle A′B′C′D′ in a sectional view created by developing the cutting plane on a flat plane when the cutting plane is a curved surface, wherein A′ and D′ are respectively the both ends of the frozen batter at the height thereof and at the inner side of the side wall of the receiving part in the sectional view, B′ is one of the both ends of the supporting surface in the longitudinal direction which is closer to A′ in the horizontal direction, and C′ is the other end closer to D′ in the horizontal direction.

10. The tray according to claim 9, wherein the partitioning protrusions have a top surface with undulations.

11. The tray according to claim 9 or 10, wherein a height of the both ends of the partitioning protrusion in the longitudinal direction is the same as or higher than a height of other parts of the partitioning protrusion.

12. A pack of frozen gyoza dumplings with a constitution in which a plurality of frozen gyoza dumplings connected by a frozen batter is arranged in the tray according to any one of claims 9 to 11.

13. A method for producing frozen gyoza dumplings consisting of a plurality of frozen gyoza dumplings connected by a frozen batter, the method comprising
a step of injecting a batter liquid in the tray according to any one of claims 9 to 11,
a step of setting an unfrozen gyoza dumpling or a frozen gyoza dumpling in each receiving part of the tray, and
a step of freezing the batter liquid injected in the tray and the unfrozen gyoza dumpling or frozen gyoza dumpling set in each receiving part of the tray while they are in contact with each other.
